(19) United States
(12) Patent Application Publication
(10) Pub. No.: US 2015/0160944 A1
(43) Pub. Date: Jun. 11, 2015

(54) SYSTEM WIDE PERFORMANCE EXTRAPOLATION USING INDIVIDUAL LINE ITEM PROTOTYPE RESULTS

(71) Applicant: INTERNATIONAL BUSINESS MACHINES CORPORATION, Armonk, NY (US)

(72) Inventors: Judith H. Bank, Cary, NC (US); Liam Harpur, Dublin (IE); Ruthie D. Lyle, Durham, NC (US); Patrick J. O'Sullivan, Dublin (IE); Lin Sun, Morrisville, NC (US)

(73) Assignee: INTERNATIONAL BUSINESS MACHINES CORPORATION, Armonk, NY (US)

(21) Appl. No.: 14/099,979

(22) Filed: Dec. 8, 2013

(51) Int. Cl. G06F 9/44

(52) U.S. Cl. CPC G06F 8/77

(57) ABSTRACT

Provided are techniques for the analysis and estimation of the impact of system wide performance by a modified software product or prototype. Using a baseline test plus a series of individual performance measurement data points collected over time, the testing of separate functional components of an overall software product or prototype is performed. Individual components may be incrementally added or modified over time in a series of ‘builds’ or packages. Techniques include detailed analysis of individual software methods and/or modules instruction by instruction, comparing each module with its baseline state to determine is changes in the performance of the module or method over time are correlated or independent of earlier states. If functions are found to be correlated with earlier module states, analysis is performed to determine which performance effects are overlapped and which are independent. Overlapped performance effects are discounted and a system wide performance estimate is produced.

### FIELD OF DISCLOSURE

The claimed subject matter relates generally to software development and, more specifically, to techniques for predicting overall performance of a projected development based upon individual line item prototype results.

### BACKGROUND OF THE INVENTION

During software product development, it is often necessary to estimate the effects of various new functions on the overall performance of a product. Because of issues such as customer complaints and competitive pressure, the product may have a performance objective such as reducing memory or CPU usage, for example, a requirement for a ten percent (10%) reduction in CPU usage. In addition, complex software products may be developed as a series of separate line items or functions that are created independently or incrementally in stages and incorporated into intermediate “builds” or executable packages. These builds and executable packages may or may not contain an amalgam of individual prototypes. Such packages typically undergo performance testing and analysis to ensure that the product is on target to meet performance goals. Further, such testing and analysis may be used to ascertain whether or not a performance benefit is worth the cost of development.

### SUMMARY

Provided are techniques for the analysis and estimation of the impact of system wide performance by a modified software product or prototype. Using a baseline test plus a series of individual performance measurement data points collected over time, the testing of separate functional components of an overall software product or prototype is performed. Individual components may be incrementally added or modified over time in a series of “builds” or packages.

Techniques include detailed analysis of individual software methods and/or modules instruction by instruction, comparing each module with its baseline state to determine if changes in the performance of the module or method over time are correlated or independent of earlier states. If functions are found to be correlated with earlier module states, analysis is performed to determine which performance effects are overlapped and which are independent. Overlapped performance effects are discounted and a system wide performance estimate is produced.

Techniques also include comparing a first performance snapshot of a first version of an application to a baseline of the application to produce a first performance delta; comparing a second performance snapshot of a second version of the application version to the baseline to produce a second performance delta; comparing the first performance delta to the second performance delta to identify a performance overlap; and generating a performance prediction, adjusted based upon the performance overlap, of a third version of the application that combines changes from the second application version to the baseline with the changes from the second application version to baseline.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is one example of a computing system architecture that may implement the claimed subject matter.

FIG. 2 is a block diagram a Software Module Performance State Analyzer (SMPSA) that may implement aspects of the claimed subject matter.

FIG. 3 is a flowchart of one example of an Analyze Test States process that may implement aspects of the claimed subject matter.

FIG. 4 is a flowchart of one example of an Analyze Modules process that may implement aspects of the claimed subject matter.

### DETAILED DESCRIPTION

Techniques include detailed analysis of individual software methods and or modules instruction by instruction, comparing each module with its baseline state to determine if changes in the performance of the module or method over time are correlated or independent of earlier states. If functions are found to be correlated with earlier module states, analysis is performed to determine which performance effects are overlapped and which are independent. Overlapped performance effects are discounted and a system wide performance estimate is produced.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks. Provided are techniques for the analysis and estimation of the impact of system wide performance by a modified software product or prototype. Using a baseline test plus a series of individual performance measurement data points collected over time, the testing of separate functional components of an overall software product or prototype is performed. Individual components may be incrementally added or modified over time in a series of ‘builds’ or packages.

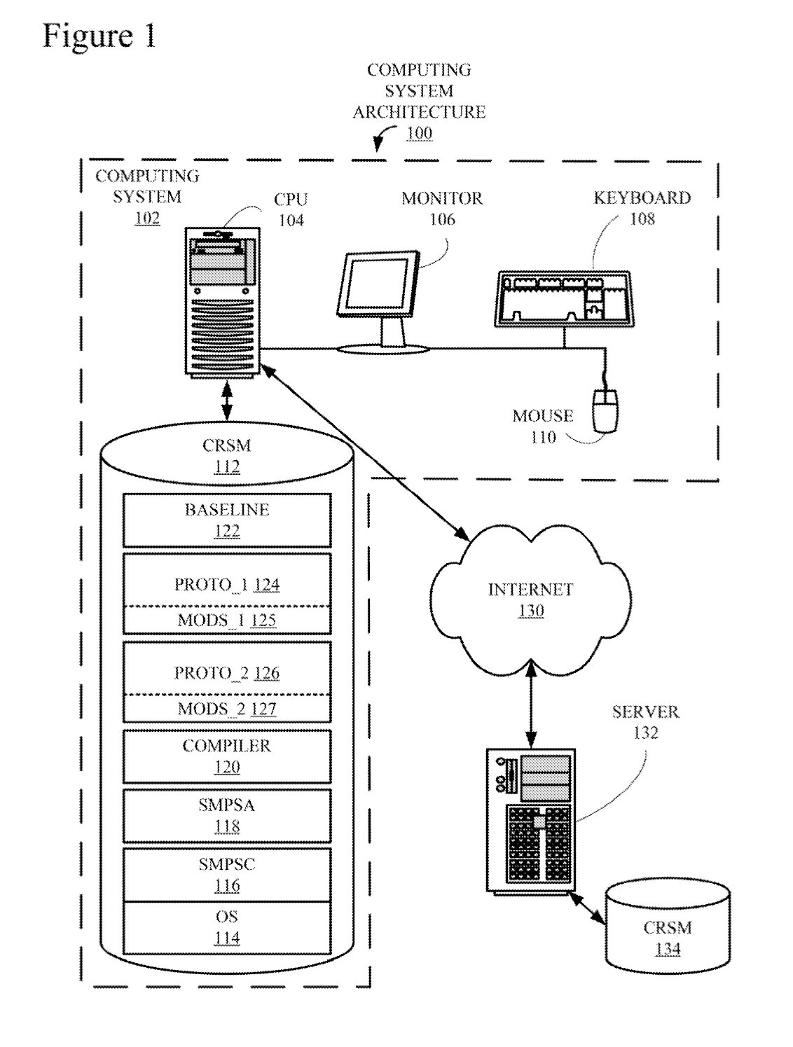

Turning now to the figures, FIG. 1 is one example of a computing system architecture 100 that may implement the claimed subject matter. A computing system system 102 includes a central processing unit (CPU) 104 with one or more processors (not shown), a monitor 106, a keyboard 108 and a pointing device, or “mouse,” 110, which together facilitate human interaction with computing system 100 and computing system 102. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown). CRSM 112 is illustrated storing an operating system (OS) 114, a Software Module Performance State Collector (SMPSC) 116, a Software Module Performance State Analyzer (SMPSA) 118, a compiler 120; a baseline module, or simply “baseline,” 122; and two application prototypes, i.e., a proto_{—}1 124 and a proto_{—}2 126. Each of prototypes 124 and 126 include a group of modules, i.e., a mods_{—}1 125 and a mods_{—}2 127, respectively. Modules 125 and 127 represent modules, or components, of the corresponding prototypes 124 and 126 that have been changed with respect to baseline 122. It should be understood that mods_{—}1 125 and mods_{—}2 127 may include the same components, completely different components or a composite of same and different components. Baseline 122, prototypes 124 and 126 and modules 125 and 127 are used as examples for the purposes of illustration.

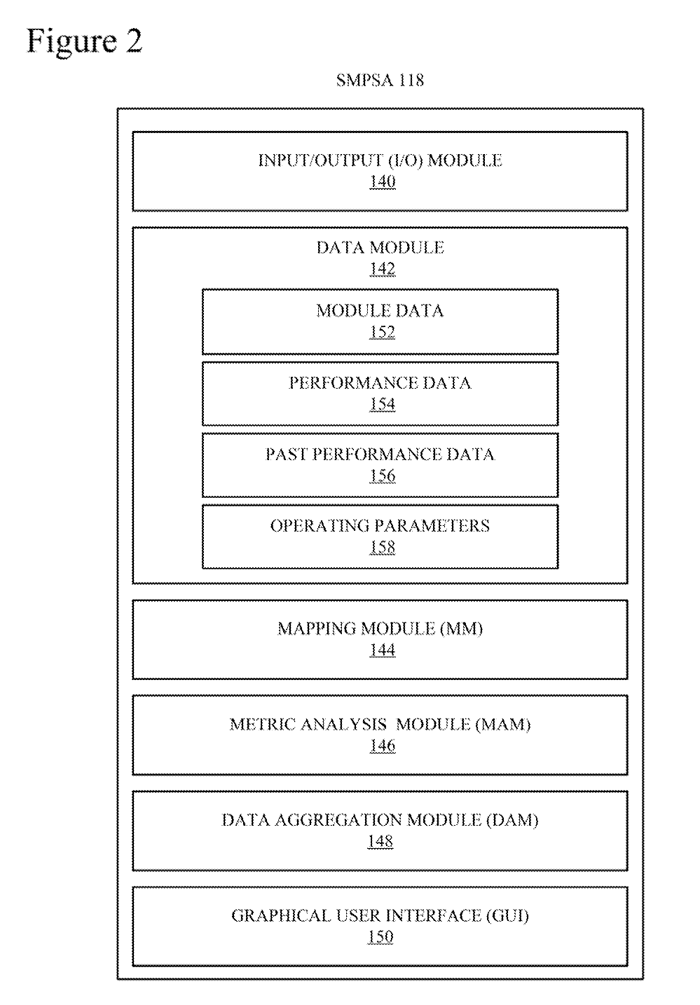

SMPSC 116 and SMPSA 118 implement the claimed subject matter and, although in this example SMPSC 116 and SMPSA 118 are implemented in software, SMPSC 116 and SMPSA 118 could also be implemented in hardware or a combination of hardware and software. Although SMPSC 116 is in this example closely coupled to OS 114, SMPSC 116 may also be implemented as a stand-alone module. In addition, SMPSA 118 may be implemented as a service and associated with logic stored and executed on a different computing system such as a CRSM 134 and a server 132, respectively. SMPSC 116 and SMPCA 118 described in more detail below in conjunction with FIGS. 2-4.

SMPSC 116 is responsible for collecting data on the performance of modules being analyzed and tested, which in the following examples include modules such as mods_{—}1 125 and mods_{—}2 127 of proto_{—}1 124 and proto_{—}2 126, respectively. Types of data collected for each machine instruction may include, but are not limited to, 1) machine operation code; 2) addresses of operands of operations captured from machine registers or assembler code; 3) fetch addresses; 4) frequency indicator for the number of executions of the instruction at a given fetch address; 5) unique identifiers for processes, address spaces or threads executing the instruction; and 6) number of cycles in the instruction and/or some indication of CPU cost and various other ‘flags’ that might be of interest, such as whether the instruction encountered a cache miss or a memory miss. SMPSC 116 may utilize these metrics if collected for sampled machine cycles rather than sampled instructions.

Computing system 102 is connected to the Internet 130, which is also connected to server computer, or simply “server,” 132. Although in this example, computing system 102 and server 132 are communicatively coupled via the Internet 130, they could also be coupled through any number of communication mediums such as, but not limited to, a local area network (LAN) (not shown). Server 132 is coupled to CRSM 134 and, like computing system 102, would typically include a CPU, monitor, keyboard and pointing device, which are not shown for the sake of simplicity. Further, it should be noted there are many possible computing system configurations, of which architecture 100 is only one simple example.

FIG. 2 is a block diagram of SMPSA 118, first introduced above in conjunction with FIG. 1, in more detail. Although in this example SMPSA 118 is implemented in software, SMPSA 118 could also be implemented in hardware or a combination of hardware and software as explained above. SMPSA 118 includes an input/output (I/O) module 140, a data module 142, a mapping module (MM) 144, a metric analysis module (MAM) 146, a Data Aggregation Module (DAM) 148 and a graphical user interface (GUI) 150. For the sake of the following examples, logic associated with SMPSA 118 is assumed to be stored on CRSM 112 (FIG. 1) and execute on computer 102 (FIG. 1). It should be understood that the claimed subject matter can be implemented in many types of computing systems and architectures but, for the sake of simplicity, is described only in terms of computing system 102 and system architecture 100 (FIG. 1). Further, the representation of SMPSA 118 in FIG. 2 is a logical model. In other words, components 140, 142, 144, 146, 148 and 150 may be stored in the same or separate files and loaded and/or executed within system 100 either as a single system or as separate processes interacting via any available inter process communication (IPC) techniques.

I/O module 140 handles any communication SMPSA 118 has with other components of architecture 100 and computing system 102. Data module 142 is a data repository for data and information that SMPSA 118 requires during normal operation. Examples of the types of information stored in data module 142 include module data 152, performance data 154, past performance data 156 and operating parameters 158. Module data 152 stores information on modules, such as mods_{—}1 125 and mods_{—}2 127, subject to analysis in accordance with the claimed subject matter the information including, but not limited to, included methods, variables and offsets. Module data 152 may also include data on the relationship between various modules, including which modules call which other modules and the correlation among different prototypes and versions of any particular module. Performance data 154 stores information including, but not limited to, data collected by SMPSC 116 (FIG. 1), collected during execution of modules subject to analysis. Past performance data 156 stores information concerning previously executed analysis of the modules and the corresponding prototypes. In this manner different prototypes of each module may be compared. Operating parameters 158 stores information that controls the look and operation of SMPSA 118.

MM 144 captures a map’ of computing system 102, such that each process or address space is mapped with regard to all modules and methods executing therein. MM 144 finds the start and end address of every method or module using, for example, control blocks or other information (such as JAVA® Method Map).

MAM 146, using a system map generated by MM 144 and data generated by SMPSC 116 (FIG. 1), builds reports showing the number of instructions and CPU cycles in each module or method for each process or address space. Briefly, MAM 146 generates reports showing the number of instructions and CPU cycles in each module or method for each process or address space by attributing each cycle or instruction sample to an address space and a specific offset in a software module or method. Using operation code information MAM 146 builds a disassembly report for each module or method showing where (at what offsets) and using what instructions the module had accumulated CPU time. MAM 146 compares multiple test snapshots (test states), one of which is designated the as the baseline test state. The system state with the latest date may be considered the aggregated (overall) comparison target state. However, in most cases, the objective is to predict the performance of an aggregated final test state for which performance data is not yet available and/or the final version of the product has not yet been built. The user may also select intermediate target states when generating an overall comparison.

Operation code information is employed to build a disassembly report for each module or method showing where (at what offsets) and using what instructions the module had accumulated CPU time. The disassembly report may also be used to calibrate offsets of code and operands from one version of the module to another (modified) version of the same module. Instructions and offsets coded in the module source but not executed during the performance measurement may not be sampled and thus might not show up in the report. It is assumed that multiple performance snapshots are equivalent in terms of workload, workload parameters, number of users, hardware configuration, and so on.

DAM 148 examines data tables produced by MAM 146 to summarize the overall independent differences and normalize correlated differences between the baseline test state and the target test state. For example if a correlated difference was based on 10% higher CPU time in a code sequence in State 1 but ⅓ fewer invocations in State 2, a normalized improvement would be 10%*0.67=6.7%

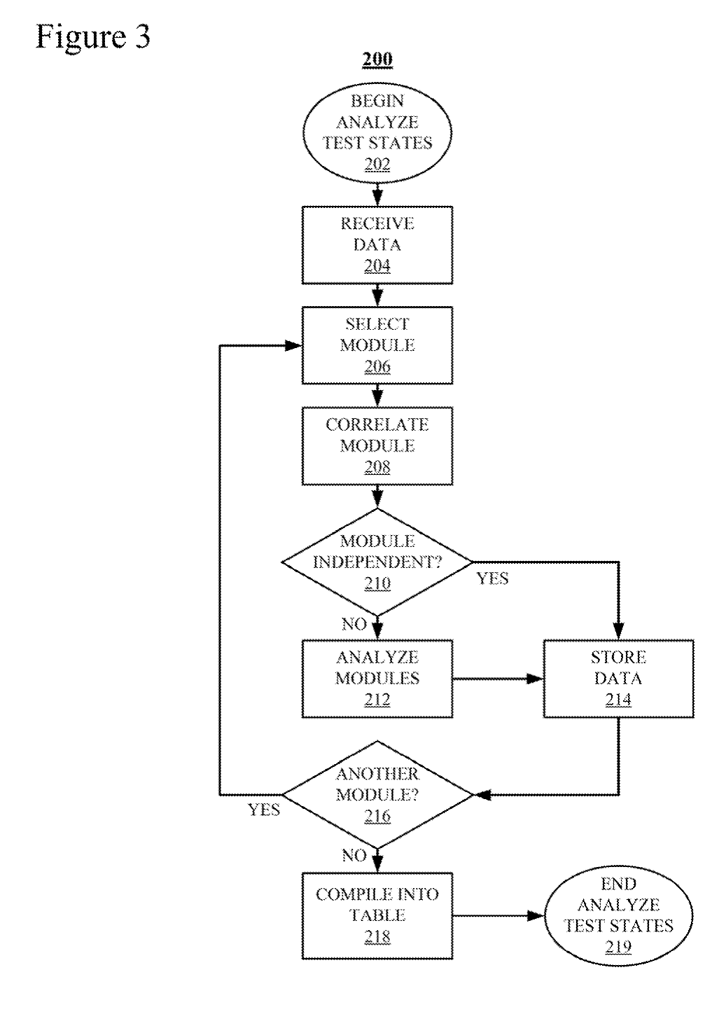

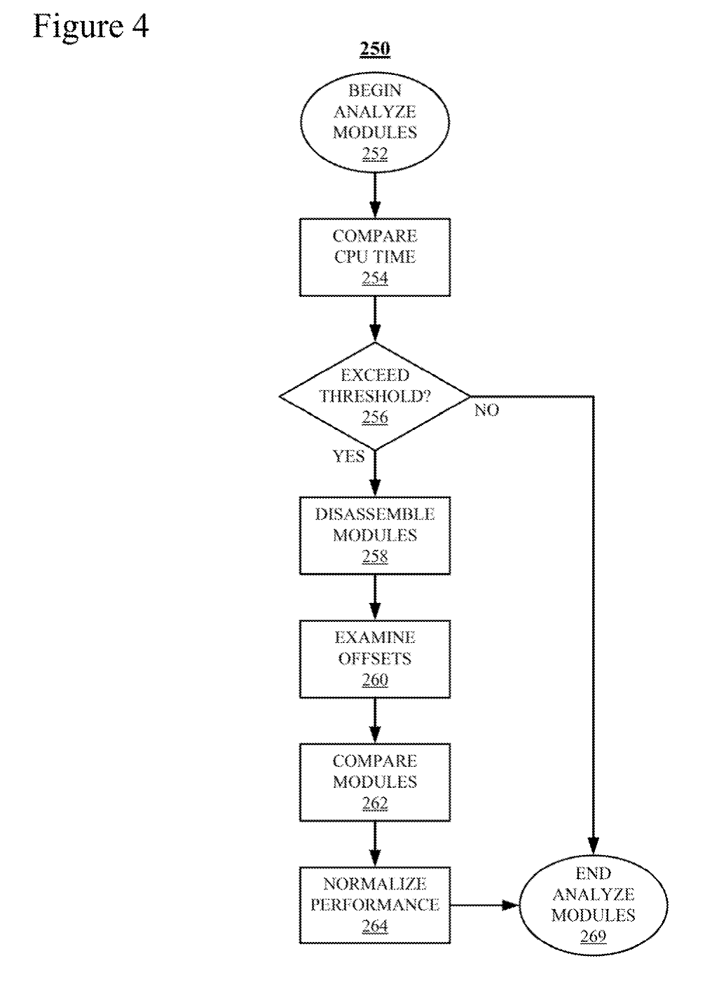

GUI component 150 enables users of SMPSA 118 to interact with and to define the desired functionality of SMPSA 118. Typically, by setting individual parameters in operating parameters 158. Components 142, 144, 146, 148, 150, 152, 154, 156 and 158 are described in more detail below in conjunction with FIGS. 3-4.

FIG. 3 is an example of a flowchart of an Analyze Test States process 200 that may implement aspects of the claimed subject matter. In this example, process 200 is associated with logic stored on CRSM 112 (FIG. 1) and executed on one or more processors (not shown) of CPU 104 (FIG. 1). It should be understood that, although process 200 is described as stored and executed in conjunction with computing system 102, process 200 may also be stored and executed on a different computing platform that the one on which the prototypes are executing, such as CRSM 134 and server 132, respectively. In addition, although described with respect to CPU usage, it should be understood that the disclosed technology is equally applicable to other computing elements and processes such as, but not limited to, real memory resources and virtual storage. Typically, the analysis of different computing elements and processes may necessitate using different detailed input data, which also could be sampled during a performance measurement.

Process 200 starts in a “Begin Analyze Test States” block 202 and proceeds immediately to a “Receive Data” block 204. During processing associated with block 204, processing data associated with a baseline test state, which in this example is baseline 122 (FIG. 1) and data from a previously executed test state, which in this example is proto_{—}1 124 (FIG. 1), are retrieved from past performance data 156 (FIG. 2) and processing data associated with a current test state, which in this example is proto_{—}2 126 (FIG. 1), is retrieved from performance data 154 (FIG. 2). In both cases, the processing data is generated by SMPSC 116 (FIG. 1) during test runs of the respective test states or prototypes. As explained above, such data may include, but is not limited to, 1) machine operation code; 2) addresses of operands of operations captured from machine registers or assembler code; 3) fetch addresses; 4) frequency indicator for the number of executions of the instruction at a given fetch address; 5) unique identifiers for processes, address spaces or threads executing the instruction; and 6) number of cycles in the instruction and/or some indication of CPU cost and various other ‘flags’ that might be of interest, such as whether the instruction encountered a cache miss or a memory miss. Examples of the retrieved data are illustrated below in conjunction with Tables 1 and 2.

During processing associated with a “Select Module” block 206, a particular module mods_{—}2 127 of proto_{—}2 126 is selected for processing in accordance with the claimed subject matter. During processing associated with a “Correlate Module” block 208, the module selected during processing associated with block 206 is matched, if possible, with the corresponding modules in mods_{—}1 125 of proto_{—}1 124. During processing associated with a “Module Independent?” block 210, a determination is made as to whether or not the selected module has a corresponding module in proto_{—}1 124, i.e. whether or not the module is “independent.” In other words, a module with no correspondence is designated as independent and a module with a corresponding module in proto_{—}1 124 is designated as “correlated.”

If the selected module is not independent, control proceeds to an “Analyze Modules” block 212. During processing associated with block 212, the selected module and the corresponding module in proto_{—}1 124 are analyzed in more detail (see 250, FIG. 4). Once the modules have been processed during processing associated with block 212 or, during processing associated with block 210, a determination is made that the module is independent, control proceeds to a “Store Data” block 214. During processing associated with block 214, the data is stored in CRSM 112 for future processing.

During processing associated with an “Another Module?” block 216, a determination is made as to whether or not there are additional modules in mods_{—}2 127 of proto_{—}2 126 to process. If so, control returns to Select Module block 206, an unprocessed module is selected and processing continues as described above. If not, control proceeds to “Compile Into Table” block 218. During processing associated with block 218, the data stored during processing associated with block 214 is summarized to calculate the overall independent differences and normalized correlated differences between the baseline test state baseline 122, proto_{—}1 124, and proto_{—}2 126 (see DAM 150, FIG. 2). Finally, control proceeds to an “End Analyze Test States” block 219 during which process 200 is complete.

FIG. 4 is a flowchart of one example of an Analyze Modules process 250 that may implement aspects of the claimed subject matter. Process 250 corresponds to Analyze Modules block 212 of process 200, both described above in conjunction with FIG. 3. Process 250 is initiated when a selected module (see 206, FIG. 3) is determined to be correlated to another module (see 208 and 210, FIG. 3). For the purposes of this description, the selected module is referred to as the “current” module and the module to which the current module is correlated as the “other” module. Like process 200, in this example, process 250 is associated with logic stored on CRSM 112 (FIG. 1) and executed on one or more processors (not shown) of CPU 104 (FIG. 1).

Process 250 starts in a “Begin Analyze Modules” block 252 and proceeds immediately to a “Compare CPU Time” block 254. During processing associated with block 254, the CPU times used by the current and other modules are compared. It should be understood that CPU time is merely used as an example of a metric that may be used in accordance with the claimed subject matter and that those with skill in the relevant arts would realize that other performance metrics are equally applicable. If the comparison metric is CPU time, MAM 146 (FIG. 2) initially calculates the difference(s) in CPU microseconds between the current module or method compared to the CPU microseconds for the other module in every other test state (i.e. test state means executing a different version or prototype).

During processing associated with an “Exceed Threshold?” block 256, a determination is made as to whether or not the difference between the CPU times exceeds a predefined threshold. The threshold is defined by a user or administrator and retrieved from operating parameters 158 (FIG. 2). An example of a threshold might be 20 microseconds. MAM 146 also calculates the total CPU time per transaction for each test state. Limiting processing to those modules that have shown a significant difference in CPU times lessens processing time by preventing insignificant changes, which may be due to factors other than improvements in efficiency, from being calculated.

If a determination is made that the difference in CPU times is significant, control proceeds to a “Disassemble Modules” block 258. During processing associated with block 258, the current and other modules are disassembled using standard techniques. During processing associated with a “Examine Offsets” block 260, the CPU and opperand offsets of the modules are compared to determine whether and/or at what offsets additional instructions, additional cycles or differing frequency of invocation has occurred between different test states of the modules. MAM 146 detects probable added or deleted code sequences within the modules. For example, some code sections may appear deleted because the data contains no samples in one or more test snapshots. In addition, MAM 146 identifies loops or code sequences in the modules based on such factors as a consecutive or nearly consecutive series of offsets all with very similar frequency samples representing approximately the same number of invocations of a series of instructions within a single test state. In most cases, a loop in one test snapshot or test state will be compared to the same loop in another test state. MAM 146 also detects whether it is probable that a code sequence has a new series of offsets based on similarities in the pattern of the instructions. If the same code sequence appears at a higher offset range, it normally indicates that new code was inserted before that sequence conversely if the offset range is lower, code was removed above. MAM 146 records the information gathered during processing associated with blocks 260 and 262 in a series of tables or a database residing on CRSM 112, examples of which are included below as Tables 1 and 2.

During processing associated with a “Compare Modules” block 262, MAM 146 identifies matching and non-matching code sequences in the modules so these sequences can be compared between test states. MAM 146 identifies causes of differences in CPU time between matching code sequences. Code sequences in one test state having no equivalents in another test state are considered independent. Non-independent, or “correlated” code sequences have dependencies such that a change in CPU time caused by one factor of a test state is offset by a change in CPU time caused by another factor in a different test state. An example of this is a reduction in CPU time in a loop in State 1 with fewer invocations of the loop in State 2. Both States have CPU decreases but, if they are merely summed, the result would be incorrect.

MAM 146 identities the causes of changed CPU time in modules and methods between test states. Some examples are fewer invocations, more efficient instructions, added code, deleted code, hardware effects like stalled pipeline, cache misses, memory misses, branch prediction misses, etc. MAM 146 identifies which test states have independent CPU changes compared to other test states. For example, Test State 2 could have reduced CPU time in a loop that is independent of test state 1 but correlated with a test state 3.

During processing associated with a “Normalize Performance” block 264, improvements in CPU time for particular loops and modules are adjusted, or “normalized,” based upon the number of times the module or loops have been called. The following tables are used as examples of data gathered and produced by SMPSC 116 (FIG. 1) and analyzed by SMPCA 118 (FIGS. 1 and 2), MAM 146 and processes 200 and 250 in accordance with the claimed subject matter.

TABLE 1

| | State 1 | | |
|---|---|---|---|
| | (baseline) | State 2 | State 3 |
| Total CPU Time per | 68.93 - | 67.52 - | 65.04 - |
| Transaction - date | 2/1/11 | 2/6/11 | 4/5/11 |
| Module Name/ | EDCXYZ - | EDCXYZ - | EDCXYZ - |
| Compile Date | 2/1/11 | 2/6/11 | 4/5/11 |
| CPU Seconds in | 4.23 | 3.97 (6.14% | 1.99 (49.87 |
| Module | | better | better |
| | | than previous) | than pervious) |
| Total Number of | 243,567,899 | 243,567,895 | 102,666,973 |
| module calls | | | |
| Equivalent Offset of | x’243a’ | x’235e’ | x’235c’ |
| Loop 1 | | | |
| Number invocations | 240,000,743 | 240,000,134 | 98,237,453 |
| of Loop 1 | | | |
| CPU time Loop 1 | 4.11 | 2.99 | 1.06 |
| Equivalent Offset of | x’4f3a’ | x’4e88’ | x’4e86’ |
| Loop 2 | | | |
| Number Invocations | 240,000,743 | 240,000,134 | 98,237,453 |
| of Loop 2 | | | |
| CPU Time Loop 2 | 0.08 | 0.09 | 0.01 |

Improvement seen in the 2/6/11 module state (State 1) is 100% correlated with the improvement in the 4/5/11 module state (State 3) because the number of calls to the module and to the main loop are significantly reduced. Therefore, we cannot count the intermediate improvement of 6.14%, and the improvement in this module is 2.24 CPU seconds, or 49.87% of this module.

TABLE 2

| | State 1 | | |
|---|---|---|---|
| | (baseline) | State 2 | State 3 |
| Total CPU Time per | 68.93 - | 69.37 - | 65.22 - |
| Transaction - date | 2/1/11 | 2/14/11 | 3/24/11 |
| Module Name/ | EDCABC - | EDCABC - | EDCABC - |
| Compile Date | 2/1/11 | 2/14/11 | 3/24/11 |
| | (baseline) | | |
| CPU Seconds in | 6.78 | 7.49 (10.47% | 5.99 (20.03 |
| Module | | worse | better |
| | | than previous) | than pervious) |
| Total Number of | 105,687 | 105,633 | 105,700 |
| module calls | | | |
| Equivalent Offset of | x'14fc' | x'14fc' | x'1696' |
| Loop 1 | | | |
| Number invocations | 105,000 | 104,999 | 103,668 |
| of Loop 1 | | | |
| CPU time Loop 1 | 3.33 | 3.89 | 3.53 |
| Equivalent | Integer | Floating point | Floating point |
| Instruction at | divide no | divide | divide |
| x'1588' | cache miss | with cache miss | no cache miss |
| Equivalent Offset of | x’eac’ | x’efc’ | x'1052' |
| Loop 2 | | | |
| Number Invocations | 50,987 | 50,886 | 50,804 |
| of Loop 2 | | | |
| CPU Time Loop 2 | 3.04 | 2.14 | 2.01 |

In Table 2, the number of invocations of the module and the loops does not change significantly. But a floating point divide instruction was substituted in the 2/14/11 module state (State 2) for the integer divide instruction and is taking a cache miss. Meanwhile the cost of loop 2 is declining over time. Loop 1 and loop 2 are not correlated so the CPU time in each can be considered separately. In module state 3/24/11 (State 3), the floating point divide instruction is no longer taking cache misses because its input data has moved into an existing cache line due to changes in the module. In this example, we would conclude that this module has improved 11.65% from the baseline. The intermediate state on 2/14/11 (State 2) had a cache miss problem that has been resolved. States 2 and 3 are 100% correlated with regard to loop 1. So the intermediate 2/14/11 loop 1 state (State 2) is not relevant since the problem was solved in the 3/24/11 state (State 3). The improvements in loop 2 are also found not to be correlated (not shown here) and should be counted as well.

Using the above data above in Table 1 and Table 2 to estimate the total system CPU resource differences per transaction between 2/1/11 and 4/5/11, the following may be concluded:
1) The correlated improvement for module EDCXYZ was 2.24 CPU seconds per transaction.
2) The correlated improvement for module EDCABC was 0.79 CPU seconds.
3) The correlated improvement in other modules not shown was 0.86 CPU seconds.
4) The overall improvement from 2/1 to 4/5 was 2.44 seconds out of 68.93 seconds or about 3.5%

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
comparing a first performance snapshot of a first version of an application to a baseline of the application to produce a first performance delta;
comparing a second performance snapshot of a second version of the application version to the baseline to produce a second performance delta;
comparing the first performance delta to the second performance delta to identify a performance overlap; and
generating a performance prediction, adjusted based upon the performance overlap, of a third version of the application that combines changes from the second application version to the baseline with the changes from the second application version to baseline.

2. The method of claim 1, wherein the performance prediction factors in information from a group consisting of:
common code to the first, second and third version;
code execution looping times;
instruction execution times;
code execution overlapping times,
sequential times;
and cache miss times.

3. The method of claim 1, wherein each of the first and second performance snapshots is an instruction trace.

4. The method of claim 1, wherein each of the first and second performance snapshots is a sample based trace.

5. The method of claim 1, wherein the changes to the first version include a modification to a first module of the application and the changes to the second version include a modification to a second module of the application that is different than the first module.

6. The method of claim 5, wherein the performance overlap is respect to the first module and the second module.

7. The method of claim 5, wherein the first version and the second version include a modification to a third module that is common to the first version and the second version.

8. An apparatus, comprising:
a processor,
a non-transitory, computer readable storage medium coupled to the processor, and
logic, stored on the computer-readable medium and executed on the processor, for:
comparing a first performance snapshot of a first version of an application to a baseline of the application to produce a first performance delta;
comparing a second performance snapshot of a second version of the application version to the baseline to produce a second performance delta;
comparing the first performance delta to the second performance delta to identify a performance overlap; and
generating a performance prediction, adjusted based upon the performance overlap, of a third version of the application that combines changes from the second application version to the baseline with the changes from the second application version to baseline.

9. The apparatus of claim 8, wherein the performance prediction factors in information from a group consisting of:
common code to the first, second and third version;
code execution looping times;
instruction execution times;
code execution overlapping times,
sequential times;
and cache miss times.

10. The apparatus of claim 8, wherein each of the first and second performance snapshots is an instruction trace.

11. The apparatus of claim 8, wherein each of the first and second performance snapshots is a sample based trace.

12. The apparatus of claim 8, wherein the changes to the first version include a modification to a first module of the application and the changes to the second version include a modification to a second module of the application that is different than the first module.

13. The apparatus of claim 12, wherein the performance overlap is respect to the first module and the second module.

14. The apparatus of claim 12, wherein the first version and the second version include a modification to a third module that is common to the first version and the second version.

15. A computer programming product, comprising:
a non-transitory, computer readable storage medium; and
logic, stored on the computer-readable medium for execution on a processor, for:
comparing a first performance snapshot of a first version of an application to a baseline of the application to produce a first performance delta;
comparing a second performance snapshot of a second version of the application version to the baseline to produce a second performance delta;
comparing the first performance delta to the second performance delta to identify a performance overlap; and
generating a performance prediction, adjusted based upon the performance overlap, of a third version of the application that combines changes from the second application version to the baseline with the changes from the second application version to baseline.

16. The computer programming product of claim 15, wherein the performance prediction factors in information from a group consisting of:
common code to the first, second and third version;
code execution looping times;
instruction execution times;
code execution overlapping times,
sequential times;
and cache miss times.

17. The computer programming product of claim 15, wherein each of the first and second performance snapshots is an instruction trace.

18. The computer programming product of claim 15, wherein each of the first and second performance snapshots is a sample based trace.

19. The computer programming product of claim 15, wherein the changes to the first version include a modification to a first module of the application and the changes to the second version include a modification to a second module of the application that is different than the first module.

20. The computer programming product of claim 19, wherein the performance overlap is respect to the first module and the second module.
